(19) United States
(12) Patent Application Publication
(10) Pub. No.: US 2017/0279958 A1
(43) Pub. Date: Sep. 28, 2017

(54) USER INTERFACE OPERATION

(71) Applicant: Lenovo (Beijing) Limited, Beijing (CN)

(72) Inventor: Yan Long Li, Beijing (CN)

(21) Appl. No.: 15/471,329

(22) Filed: Mar. 28, 2017

(30) Foreign Application Priority Data
Mar. 28, 2016 (CN) 201610183735.1

(51) Int. Cl. H04M 1/725; H04L 12/24

(52) U.S. Cl. CPC H04M 1/72583; H04L 41/22

(57) ABSTRACT

A method includes detecting a dragging operation on a first interface object displayed by a display unit of an electronic device. The first interface object includes a first time information. The method also includes adjusting the first time information to a second time information in response to the dragging operation.

### FIELD

The subject matter disclosed herein relates to the field of computer technologies, and in particular, to an information processing method and an electronic device.

### BACKGROUND

At present, with the increasingly rapid pace of work and life, a user often needs to deal with a lot of things. In order not to forget these things, the user often sets memos in an electronic device or sets an alarm for everything through an alarm function on the electronic device, for example, “Meeting at 9:30” or “Visit a client at 10:00”. In the prior art, if something is postponed, for example, the meeting is changed to 11 o'clock, the user often needs to enter an alarm setting interface of the electronic device to adjust a time for the “Meeting at 9:30”, that is, adjust “9:30” to “11:00”. The operation is quite complex, and the electronic device needs to respond to the user's operations repeatedly, resulting in high power consumption.

### SUMMARY

One embodiment of the present disclosure includes a method. The method includes detecting a dragging operation on a first interface object displayed by a display unit of an electronic device. The first interface object includes a first time information. The method also includes adjusting the first time information to a second time information in response to the dragging operation.

Another embodiment of the present disclosure includes a device. The electronic device includes a display unit, a sensor, and a processor. The sensor detects a dragging operation on a first interface object displayed by the display unit. The first interface object comprises a first time information. The processor adjusts the first time information to a second time information in response to the dragging operation.

Another embodiment of the present disclosure includes a system. The system includes a display unit, an acquisition module, and an adjustment module. The acquisition module detects a dragging operation on a first interface object displayed by the display unit of the electronic system. The first interface object includes a first time information. The adjustment module adjusts the first time 8information to a second time information in response to the dragging operation.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a flow diagram of an information processing method in an embodiment of the present disclosure.

FIGS. 2A and 2B are first schematic diagrams illustrating adjustment of a first time information to a second time information in an embodiment of the present disclosure.

FIGS. 3A and 3B are second schematic diagrams illustrating adjustment of a first time information to a second time information in an embodiment of the present disclosure.

FIG. 4 is a schematic diagram of an electronic device in an embodiment of the present disclosure.

FIG. 5 is a schematic structural diagram of an electronic device in an embodiment of the present disclosure.

### DETAILED DESCRIPTION

In order to make the objectives, technical solutions, and advantages of the present disclosure more comprehensible, the technical solutions in the embodiments of the present disclosure will be clearly and expressly described below with reference to the accompanying drawings in the embodiments of the present disclosure. It is obvious that the embodiments to be described herein are merely some, rather than all of the embodiments of the present disclosure. All other embodiments derived by those of ordinary skill in the art, based on the embodiments in the present disclosure without creative efforts, should fall within the protection scope of the present disclosure. The embodiments in the present disclosure and features in the embodiments may be combined randomly with one another without conflicts. While a logical order is shown in the flow diagram, the steps shown or described can, in some circumstances, be executed in a different order than presented herein.

Optionally, in the embodiments of the present disclosure, the electronic device may include different electronic devices such as a personal computer (PC), a tablet computer (Portable Android Device, PAD), or a mobile phone, therefore it is not limited in the embodiments of the present disclosure.

In addition, the term “and/or” herein indicates only an association relationship for describing associated objects and indicates that three relationships may exist. For example, A and/or B may indicate the following three cases: only A exists, both A and B exist, and only B exists. In addition, the symbol “/” herein, if not specified, generally indicates an “or” relationship between the associated objects.

Preferred implementation manners of the present disclosure are described in detail below with reference to the accompanying drawings.

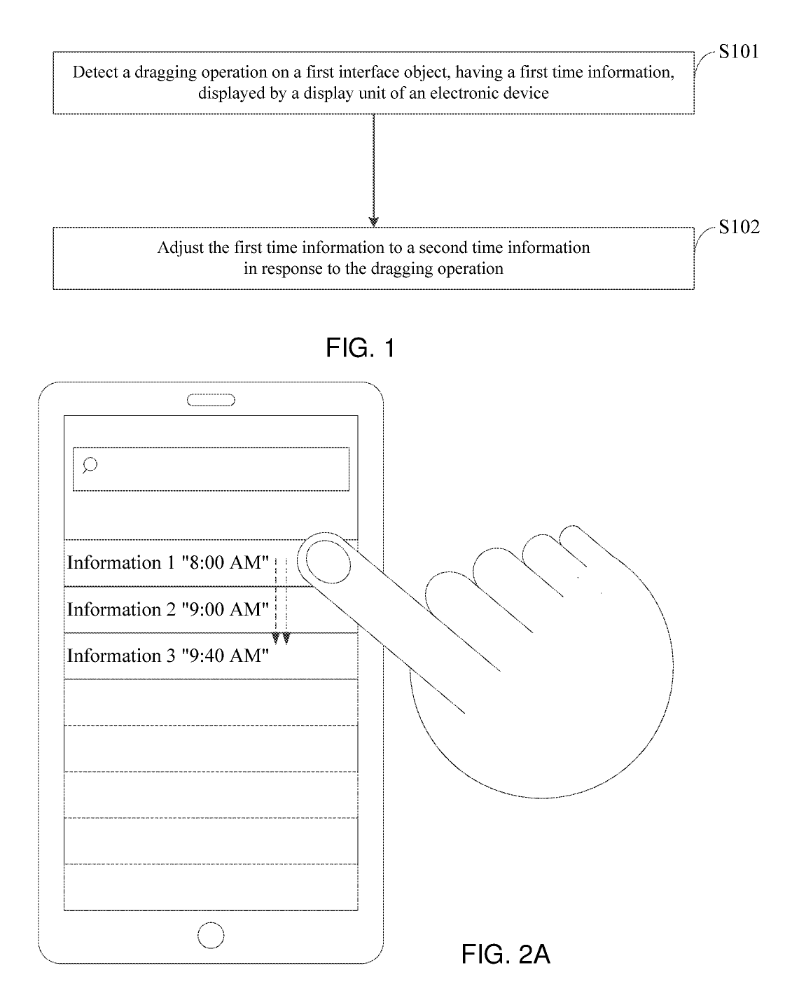

Referring to FIG. 1, an embodiment of the present disclosure provides an information processing method. The main flow of the method is described as follows.

At block S101, a dragging operation is detected on a first interface object displayed by a display unit of an electronic device. At block S102, the first time information is adjusted to a second time information in response to the dragging operation.

In some embodiments, the display unit may be a flexible display unit, that is, a deformable display unit, or the display unit may be a non-flexible display unit, and the like. The type of the display unit is not limited in the embodiments of the present disclosure.

In some embodiments, the first interface object may include information in a memo in the electronic device. For example, the first interface object may include meeting reminder information, such as: “Meeting Reminder: 11:25 AM”. Or, the first interface object may include alarm information in the electronic device, such as: “Wake Up Alarm: 8:00 AM”, and the like. The above are merely examples, therefore the content of the first interface object is not limited in the embodiments of the present disclosure.

In some embodiments, the dragging operation may include a sliding operation of the user, such as a sliding touch operation performed by the user on the display unit with a finger. For example, the user may select the first interface object with the index finger, for example, presses and holds the first interface object with the index finger, then, the user's index finger slides on the display unit without leaving the surface of the display unit, and the first interface object may move along with the user's index finger. Or, the dragging operation may include a dragging operation performed by the user on the first interface object with an electronic stylus. The above are merely examples, therefore the implementation manner of the dragging operation is not limited in the embodiments of the present disclosure.

In some embodiments, a time indicated in the second time information may occur after (i.e. be larger than) a time indicated in the first time information, or a time indicated in the second time information may occur before (i.e. be smaller than) a time indicated in the first time information. The relationship between the time indicated in the second time information and the time indicated in the first time information is not limited in the embodiments of the present disclosure.

In other embodiments, there are many manners for adjusting the first time information to the second time information according to the dragging operation, and description is made below with examples.

In one embodiment, the device may adjust the first time information to the second time information based on the display position of the first interface object on the display unit at the end of the dragging operation.

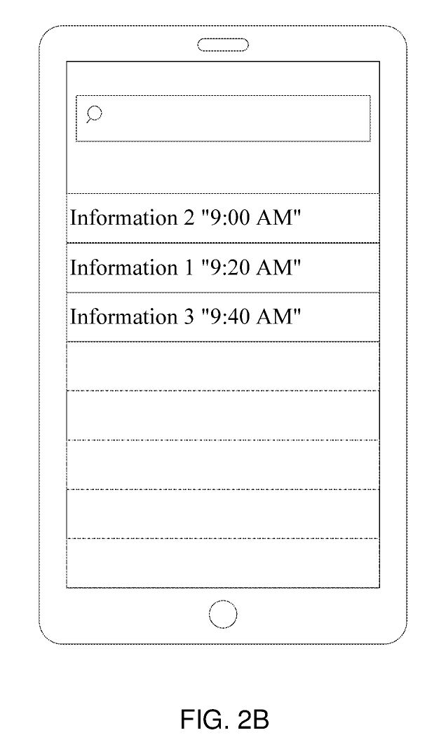

For example, referring to FIG. 2A to FIG. 2B, if the display position of the first interface object in the display unit is between a third interface object and a fourth interface object at the end of the dragging operation, a third time information in the third interface object and a fourth time information in the fourth interface object are acquired. The first time information is adjusted to the second time information based on the acquired third time information and the acquired fourth time information.

For example, the first interface object, the third interface object, and the fourth interface object may be displayed on the display unit in the form of entries. For example, the whole display unit can display multiple entries, that is, the display unit can display multiple rows of information. In the illustrated embodiment, three pieces of information exist on the whole display unit, and one possible display manner is: for example, Information 1 (that is, the first interface object), Information 2 (that is, the third interface object), and Information 3 (that is, the fourth interface object) exist sequentially from top to bottom. That is, Information 1 is displayed in the first row, and the first time information of Information 1 is “8:00 AM.” Information 2 is displayed in the second row and the third time information of Information 2 is “9:00 AM.” Information 3 is displayed in the third row, and a fourth time information of Information 3 is “9:40 AM.” In some embodiments, the user drags Information 1 down to adjust the time of Information 1. For example, the user may drag Information 1 to be between Information 2 and Information 3. As a result, Information 2 is then located in the first row, Information 1 is located in the second row, and Information 3 is located in the third row. The first time information of Information 1 may be adjusted to a time between the third time information of Information 2 and a time indicated by the fourth time information of Information 3. For example, a second time information of Information 1 may be “9:20 AM”, that is, a time between “9:00 AM” and “9:40 AM”. In this way, the user does not need to access the details of Information 1 and make adjustment to a specific time, but only needs to drag the position of the corresponding interface object to a corresponding location, so that the operation is convenient; meanwhile, the electronic device does not need to make complex responses, thereby improving operation efficiency of the electronic device and the user experience.

In some embodiments, the second time information may be determined according to whichever of the third time information and the fourth time information is sooner. For example, it may be determined whether the third time information is sooner or smaller than the fourth time information. If the third time information is sooner in time than the fourth time information, the third time information may be stored and increased by a first time length to obtain the second time information. Alternatively, if the fourth time information is sooner in time than the third time information, the fourth time information may be stored and increased by a first time length to obtain the second time information. The first time information is then adjusted to the second time information.

For example, still using the third interface object being “9:00 AM” and the fourth time information being “9:40 AM” as an example, since the third time information is 9 o'clock, while the fourth time information is 9:40, so that the third time information is a time sooner than the fourth time information. In other words, the second time information may be determined based on the third time information of “9:00” which is increased by the first time length to determine the adjusted time. The first time length may be set by those skilled in the art upon manufacturing of the electronic device, for example, the first time length may be 10 minutes, that is, the second time information may be set to “9:10 AM”. Or, the first time length is set by the user. For example, in the embodiments of the present disclosure, a setup menu may pop up in the electronic device to remind the user to set the first time length. For example, the first time length set by the user is 5 minutes, and then the second time information may become “9:05 AM”. In this way, the user does not need to manually adjust the first time information in the first interface object but needs only drag the first interface object to adjust the first time information to the second time information. For example, the user looks at the display and notes in the electronic device display three things (that is, the first interface object, the third interface object, and the fourth interface object), and if an event in the first interface object is postponed, the user only needs to drag the first interface object below the third interface object. The electronic device can then automatically adjust the moment in the first interface object, thereby improving the user experience.

In some embodiments, the third interface object is sooner than the fourth interface object. If the fourth interface object is determined to be sooner than the third interface object, the second time information may be determined according to the fourth interface object.

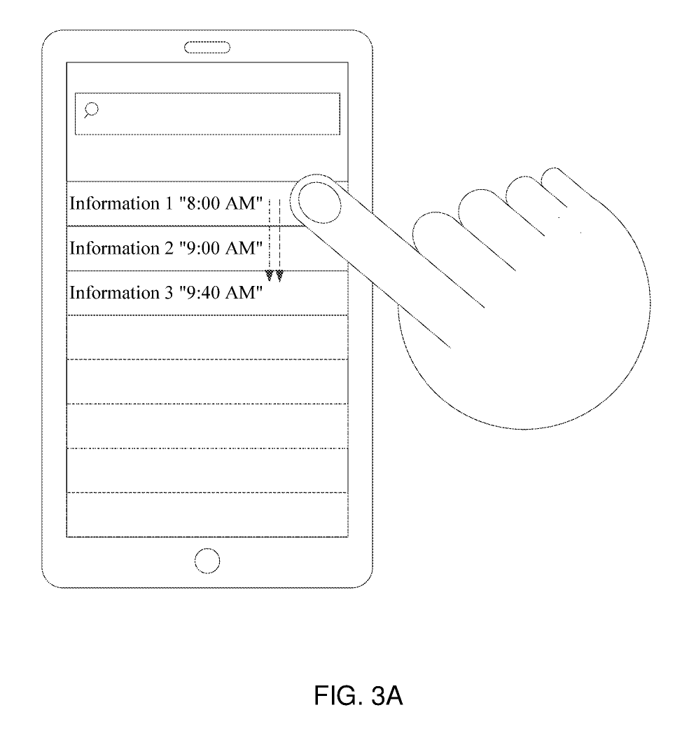

FIG. 3A to FIG. 3B illustrate another embodiment. In the illustrated embodiment, after the first time information is adjusted to the second time information, the fourth time information may be saved and postponed by the first time length to obtain a fifth time information. The fourth time information is adjusted to the fifth time information.

For example, with the third interface object being “9:00 AM” and the fourth time information being “9:40 AM”, the second time information is adjusted to “9:10 AM”, and then, a fifth time information may be determined based on the fourth time information. In one example, the fourth time information is “9:40” and the first time length increased by 10 minutes accordingly, the determined fifth time information is “9:50.” In other words, the original fourth time information in the fourth interface object is adjusted to the fifth time information. In other words, times coming after the second time information will be automatically postponed. For example, the user may have three meetings sequentially at three separate times (that is, the first interface object, third interface object, and fourth interface object). If the first meeting is changed to a time after the second meeting, the third meeting will be automatically postponed, which improves the user's environment and further improves the user experience.

In another embodiment, a movement track of the dragging operation is acquired. If the movement track is a first track, the first time information is increased by a preset time length to obtain the second time information. If the movement track is a second track, the first time information is decreased by a preset time length to obtain the second time information. The first time information is then adjusted to the second time information.

In another embodiment, the first dragging operation track and the second dragging operation track may both be set to a standard or preset value. For example, the first track may be a track starting with the current position of the first interface object in the display unit and moving to the lower side of the display unit. The second track may be a track starting with the current position of the first interface object in the display unit and moving to the upper side of the display unit. The above is merely an example, therefore the setting manner of the first track and the second track is not limited in the embodiments of the present disclosure.

In one example, the display unit displays the first interface object in which the preset time length is 1 hour. The first time information in the first interface object is “10:00 AM.” The user drags the first interface object upward and “10:00 AM” is adjusted to “9:00 AM” (that is, decreased by the preset time length), or the user moves the first interface object downward, and subsequently “10:00 AM” is adjusted to “11:00 AM” (that is, increased by the preset time length). In this way, the user does not need to manually adjust a time of the event, and only needs to drag the whole interface object to achieve the effect of changing the time, so that the operation is convenient; meanwhile, a habitual operating manner of the user may be set to the first track and the second track, so as to conform to the user's operating habit and improve the user experience.

In another embodiment, the number of dragging operations acquired in a first preset time length is determined and set as a first number. The first time information is increased by the first number of preset time lengths to obtain the second time information.

In some embodiments, the preset time length may be a second preset time length and the first preset time length and the second preset time length may be set to a default value, dynamically, or set by the user. The setting manner of the first preset time length and the second preset time length is not limited in the embodiments of the present disclosure.

In one embodiment, we may assume the first preset time length is 1 second, and the second preset time length is 10 minutes. If the user drags the first interface object with a finger, the electronic device starts timing and acquires the number of dragging operations performed by the user on the first interface object within 1 second. In some embodiments, when the user's finger leaves the display unit, the first interface object may return to the position before being dragged. After 1 second, the electronic device increases the moment indicated in the first time information in the first interface object by three second preset time lengths, that is, postpones the first time information by 30 minutes (that is, adjusts the first time information to a second time information). In this way, the user does not need to manually adjust the first time information, and only needs to make adjustment through the number of times of dragging, which is convenient and rapid and improves the user experience.

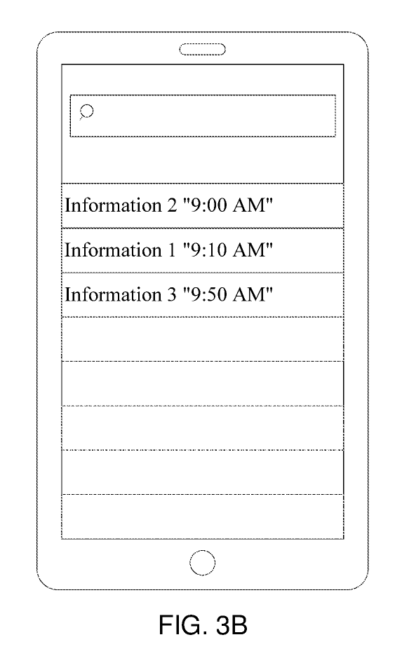

Referring to FIG. 4, an embodiment of the present disclosure further provides an electronic device, which includes, a display unit 401, a sensor 402, and a processor 403, where the sensor 402 acquires a dragging operation performed by a user on a first interface object displayed by the display unit 401, wherein the first interface object includes first time information. The processor 403 adjusts the first time information to a second time information according to the dragging operation.

In some embodiments, the processor 403 adjusts the first time information to the second time information according to a display position of the first interface object on the display unit 401 at the end of the dragging operation.

In another embodiment, the processor 403 acquires a third time information from a third interface object and a fourth time information in a fourth interface object if the display position of the first interface object in the display unit 401 is between a third interface object and a fourth interface object at the end of the dragging operation. The processor also adjusts the first time information to the second time information based on the value of the third time information and the fourth time information. In some embodiments, the second time information is between the third time information and the fourth time information.

In some embodiments, the processor 403 determines whether the third time information occurs before (or is smaller than) the fourth time information. The processor 403 increases the third time information by a first time length to obtain the second time information if the moment indicated by the third time information occurs before the fourth time information; or, increases the fourth time information by a first time length to obtain the second time information if the fourth time information occurs before the third time information. The processor 403 also adjusts the first time information to the second time information based on the determinations described above.

In some embodiments, the processor 403 postpones, after adjusting the first time information to the second time information, the fourth time information by the first time length to obtain a fifth time information if the third time information occurs before the fourth time information; and adjust the fourth time information to the fifth time information.

In some embodiments, the processor 403 may acquire a movement track of the dragging operation. If the movement track is a first track, the processor 403 may increase the first time information by a preset time length to obtain the second time information. Alternatively, if the movement track is a second track, the processor 403 may decrease the first time information by a preset time length to obtain the second time information. The processor 403 may then adjusts the first time information to the second time information.

In another embodiment, the processor 403 may determine the number of dragging operations which occur in a first preset time length as a first number. The processor 403 may then increase the first time information by the first number of preset time lengths to obtain the second time information.

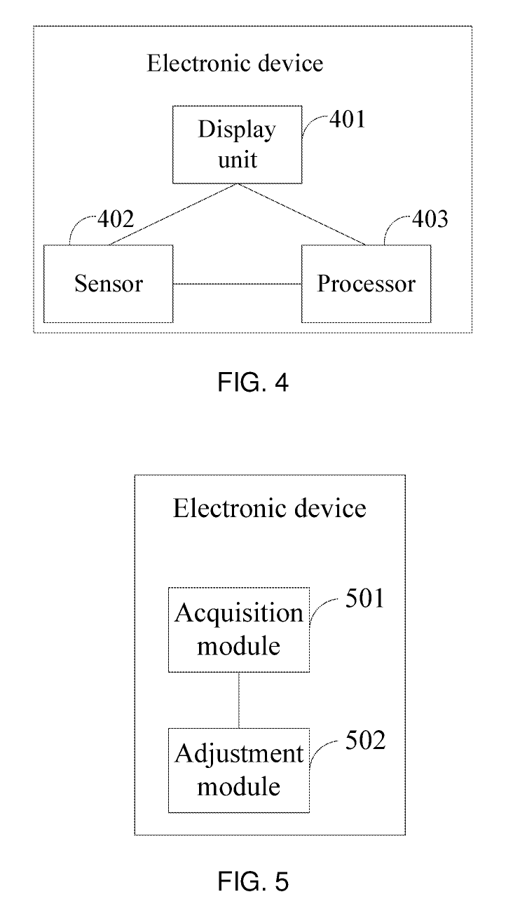

Referring to FIG. 5, an embodiment of the present disclosure further provides another electronic device. In the illustrated embodiment, the electronic device includes an acquisition module 501 and an adjustment module 502. The acquisition module acquires a dragging operation performed by a user on a first interface object displayed by a display unit of the electronic device. The first interface object includes a first time information. The adjustment module 502 adjusts the first time information to a second time information based on the dragging operation.

In some embodiments, the adjustment module 502 adjusts the first time information to the second time information based on the display position of the first interface object on the display unit at the end of the dragging operation.

In another embodiment, the adjustment module 502 acquires a third time information in the third interface object and a fourth time information in the fourth interface object if the display position of the first interface object in the display unit is between a third interface object and a fourth interface object at the end of the dragging operation. The adjustment module 502 also adjusts the first time information to the second time information according to the third time information and the fourth time information. The second time information is between the third time information and the fourth time information.

In some embodiments, the adjustment module 502 determines whether the third time information occurs before the fourth time information after acquiring the third time information from the third interface object and the fourth time information from the fourth interface object. The adjustment module 502 also increases the third time information by a first time length to obtain the second time information if the third time information occurs before the fourth time information. Alternatively, the adjustment module 502 may increase the fourth time information by a first time length to obtain the second time information if the fourth time information occurs before the third time information. The adjustment module 502 may then adjust the first time information to the second time information.

In another embodiment, the adjustment module 502 postpones, after adjusting the first time information to the second time information, the fourth time information by the first time length to obtain a fifth time information if the third time information occurs before the fourth time information and adjusts the fourth time information to the fifth time information.

In some embodiments, the adjustment module 502 acquires a movement track of the dragging operation. If the movement track is a first track, the adjustment module 502 increases the first time information by a preset time length to obtain the second time information. Alternatively, if the movement track is a second track, the adjustment module 502 may decrease the first time information by a preset time length to obtain the second time information. The adjustment module 502 then adjusts the first time information to the second time information.

In some embodiments, the adjustment module 502 determines a number of dragging operations acquired during a first preset time length as a first number, and increases the first time information by the first number of preset time lengths to obtain the second time information.

In the embodiments of the present disclosure, the electronic devices described in FIG. 4 to FIG. 5 correspond to the information processing method described in FIG. 1, and reference may be made to each other for the implementation manners. Therefore, the repeated parts will not be described again in the description of the electronic devices.

The one or more technical solutions in the embodiments of the present disclosure have at least the following one or more technical effects and advantages.

In the embodiments of the present disclosure, a first time information in a first interface object can be adjusted through a dragging operation performed by a user on the first interface object. The user does not need to make adjustment to identify a particular timeframe, so that the users' operation time is saved, and the user experience is improved. Furthermore, the electronic device does not need to respond to complex operations of the user, so that operation efficiency of the electronic device is improved, and power consumption of the electronic device in responding to the operations is reduced.

Those skilled in the art may clearly understand that, for the purpose of convenient and brief description, the division of functional modules is merely an example for description. In actual application, the foregoing functions may be allocated to different functional modules for completion according to requirements. In other words, the internal structure of the device is divided into different functional modules, so as to complete all or part of the functions described above. For the detailed working process of the system, device, and unit described above, reference may be made to the corresponding process in the foregoing method embodiment, therefore details are not described herein again.

In the several embodiments provided in the present disclosure, it should be understood that the disclosed system, device, and method may be implemented in other manners. For example, the device embodiments described above are merely exemplary. For example, the division of modules or units is merely logical function division, but may be otherwise divided in actual implementation. For example, a plurality of units or components may be combined or integrated into another system, or some features may be ignored or not performed. In addition, the displayed or discussed mutual couplings or direct couplings, or communication connections may be implemented through some interfaces. The indirect couplings or communication connections between the devices or units may be implemented electrically, mechanically, or in other forms.

The units described as separate parts may be or may not be physically separated. The parts displayed as units may be or may not be physical units, that is, may be located at one place or distributed on a plurality of network units. Some or all of the units may be selected to achieve the objective of the solution of the embodiment according to actual demands.

In addition, the functional units in the embodiments of the present disclosure may be integrated into one processing unit or each of the units may exist alone physically, or two or more units may be integrated into one unit. The integrated unit may be implemented in the form of hardware or implemented in the form of a software functional unit.

When being implemented in the form of a software functional unit and sold or used as a separate product, the integrated unit may be stored in a computer readable storage medium. Based on such understanding, the essence of the technical solution of the present disclosure or the part that makes contributions to the prior art, or all or part of the technical solution can be embodied in the form of a software product. The computer software product is stored in a storage medium and includes several instructions for instructing a computer device (which may be a personal computer, a server, a network device, or the like) or a processor to perform all or some of the steps of the methods described in the embodiments of the present disclosure. The storage medium includes any medium that is capable of storing program codes, such as a USB flash drive, a removable hard disk, a read-only memory (ROM), a random access memory (RAM), a magnetic disk, or an optical disc.

Specifically, computer program instructions corresponding to an information processing method in an embodiment of the present disclosure may be stored in a storage medium such as an optical disc, a hard disk, or a USB flash drive.

Although preferred embodiments of the present disclosure have been described, those skilled in the art can make additional alterations and modifications to these embodiments as soon as they know the basic creative concept. Therefore, the appended claims are intended to be interpreted as covering preferred embodiments and all alterations and modifications falling within the scope of the present disclosure.

It will be apparent to those skilled in the art that various modifications and variations can be made to the present disclosure without departing from the spirit and scope of the present disclosure. In view of the foregoing, it is intended that the present disclosure cover modifications and variations of the present disclosure provided they fall within the scope of the claims of the present disclosure and their equivalents.

What is claimed is:

1. A method, comprising:
detecting a dragging operation on a first interface object displayed by a display unit of an electronic device, wherein the first interface object comprises a first time information; and
adjusting the first time information to a second time information in response to the dragging operation.

2. The method according to claim 1, wherein adjusting the first time information to the second time information in response to the dragging operation comprises:
adjusting the first time information to the second time information in response to a display position of the first interface object on the display unit at an end of the dragging operation.

3. The method according to claim 2, further comprising:
acquiring a third time information of a third interface object and a fourth time information of a fourth interface object in response to a determination that the display position of the first interface object in the display unit is between the third interface object and the fourth interface object at the end of the dragging operation; and
adjusting the first time information to the second time information based on the third time information and the fourth time information, wherein the second time information is between the third time information and the fourth time information.

4. The method according to claim 3, wherein the method further comprises:
determining whether the third time information occurs before the fourth time information;
increasing the third time information by a first time length to obtain the second time information in response to a determination that the third time information occurs sooner than the fourth time information; increasing the fourth time information by the first time length to obtain the second time information in response to a determination that the fourth time information occurs sooner than the third time information; and
adjusting the first time information of the first interface object to the second time information.

5. The method according to claim 4, wherein the method further comprises:
postponing the fourth time information by the first time length to obtain a fifth time information; and
adjusting the fourth time information to the fifth time information.

6. The method according to claim 1, wherein adjusting the first time information to a second time information in response to the dragging operation comprises:
detecting a movement track of the dragging operation;
increasing the first time information by a preset time length to obtain the second time information in response to a determination that the movement track is a first track;
decreasing the first time information by the preset time length to obtain the second time information in response to a determination that the movement track is a second track; and
adjusting the first time information to the second time information.

7. The method according to claim 1, wherein the adjusting the first time information to the second time information in response to the dragging operation comprises:
determining a number of dragging operations acquired in a first preset time length; and
adjusting the first time information by a number of preset time lengths, corresponding to the number of dragging operations, to obtain the second time information.

8. A device, comprising:
a display unit;
a sensor that detects a dragging operation on a first interface object displayed by the display unit, wherein the first interface object comprises a first time information; and
a processor that adjusts the first time information to a second time information in response to the dragging operation.

9. The device according to claim 8, wherein the processor further:
adjusts the first time information to the second time information in response to a display position of the first interface object on the display unit at an end of the dragging operation.

10. The device according to claim 9, wherein the processor further:
acquires a third time information of a third interface object and a fourth time information of a fourth interface object in response to a determination that the display position of the first interface object in the display unit is between third interface object and the fourth interface object at the end of the dragging operation; and
adjusts the first time information to the second time information based on the third time information and the fourth time information, wherein the second time information is between the third time information and the fourth time information.

11. The device according to claim 10, wherein the processor further:
determines whether the third time information occurs before the fourth time information;
adjusts the third time information by a first time length to obtain the second time information in response to a determination that the third time information occurs before the fourth time information;
adjusts the fourth time information by the first time length to obtain the second time information in response to a determination that the fourth time information occurs before the third time information; and
adjusts the first time information to the second time information.

12. The device according to claim 11, wherein the processor further:
postpones the fourth time information by the first time length to obtain a fifth time information in response to a determination that the third time information occurs before the fourth time information; and
adjusts the fourth time information to the fifth time information.

13. The device according to claim 8, wherein the processor further:
detects a movement track of the dragging operation;
increases the first time information by a preset time length to obtain the second time information in response to a determination that the movement track is a first track;
decreases the first time information by a preset time length to obtain the second time information in response to a determination that the movement track is a second track; and
adjusts the first time information to the second time information.

14. The device according to claim 8, wherein the processor further:
determines the number of dragging operations acquired in a first preset time length; and
adjusts the first time information a number of preset time lengths, corresponding to the number of dragging operations, to obtain the second time information.

15. A system, comprising:
a display unit;
an acquisition module that detects a dragging operation on a first interface object displayed by the display unit of the electronic system, wherein the first interface object comprises a first time information; and
an adjustment module that adjusts the first time information to a second time information in response to the dragging operation.

16. The system according to claim 15, wherein the adjustment module further:
adjusts the first time information to the second time information in response to a display position of the first interface object on the display unit at an end of the dragging operation.

17. The system according to claim 16, wherein:
the acquisition module further acquires a third time information of a third interface object and a fourth time information of a fourth interface object in response to a determination that the display position of the first interface object in the display unit is between third interface object and the fourth interface object at the end of the dragging operation; and
the adjustment module further adjusts the first time information to the second time information based on the third time information and the fourth time information, wherein the second time information is between the third time information and the fourth time information.

18. The system according to claim 17, wherein the adjustment module further:
determines whether the third time information occurs before the fourth time information;
adjusts the third time information by a first time length to obtain the second time information in response to a determination that the third time information occurs before the fourth time information;
adjusts the fourth time information by the first time length to obtain the second time information in response to a determination that the fourth time information occurs before the third time information; and
adjusts the first time information to the second time information.

19. The system according to claim 18, wherein the adjustment module further:
postpones the fourth time information by the first time length to obtain a fifth time information in response to a determination that the third time information occurs before the fourth time information; and
adjusts the fourth time information to the fifth time information.

20. The system according to claim 18, wherein the adjustment module further:
detects a movement track of the dragging operation;
increases the first time information by a preset time length to obtain the second time information in response to a determination that the movement track is a first track;
decreases the first time information by a preset time length to obtain the second time information in response to a determination that the movement track is a second track; and
adjusts the first time information to the second time information.
